(19) United States
(12) Patent Application Publication
(10) Pub. No.: US 2004/0088172 A1
(43) Pub. Date: May 6, 2004

(54) Method and apparatus for real estate agent selection

(76) Inventor: Martin A. Baglioni, Fort Lauderdale, FL (US)

Correspondence Address: LITTMAN LAW OFFICES, LTD., P.O. BOX 15035 CRYSTAL CITY STATION, ARLINGTON, VA, 22215, US

(21) Appl. No.: 10/285,538

(22) Filed: Nov. 1, 2002

(51) Int. Cl. G06F 17/60

(52) U.S. Cl. 705/1

(57) ABSTRACT

A method and apparatus for real estate agent selection based on real estate agent data based on performance. An apparatus for real estate real estate agent selection includes at least one real estate customer, a real estate server, and a real estate agent database. A method for real estate agent selection provides at least one real estate customer, a real estate server communicatively connected to the at least one real estate customer, and a real estate agent database communicatively connected to the real estate server, and accesses the real estate agent database and determines at least one real estate agent based on received seller or buyer input data, the received real estate property data associated with the received selling or buying input data, and received real estate agent customer data, the at least one real estate agent having earned more than a predetermined amount during a designated time period.

### BACKGROUND OF THE INVENTION

1. Field of the Invention

The present invention relates generally to real estate agents and, more particularly to a method and apparatus for real estate agent selection.

2. Description of the Related Art

Many individuals buy or sell real estate property. Generally, such an individual obtains a real estate agent who obtains a commission on any property he buys or sells for an individual. Currently, there are systems and techniques for obtaining real estate agent data corresponding to geographical location, price, etc. However, no method and apparatus for real estate agent selection currently exists that provides qualified real estate agent data, e.g., real estate agent data that includes data based on performance. High real estate agent performance typically results in high real estate agent earnings, such as earnings over about $250,000 a year. There is a need for a method and apparatus for real estate agent selection real estate agent data that includes data based on performance.

The related art is represented by the following references of interest.

U.S. Patent Application Publication No. 2002/0007340 A1, published on Jan. 17, 2002 for Stephen T. Isaf et al., describes a Partner Relationship system accessible for buyers located remotely, whereby the buyers' access privileges are based on their relationship with the sellers. The Isaf et al. application does not suggest a method and apparatus for real estate agent selection according to the claimed invention.

U.S. Patent Application Publication No. 2002/0095346 A1, published on Jul. 18, 2002 for Bennett J. Liss, describes a system for marketing real estate that includes a venue containing potentially interested and qualified real estate buyers controlled by a venue operator. The Liss application does not suggest a method and apparatus for real estate agent selection according to the claimed invention.

U.S. Patent Application Publication No. 2002/0123959 A1, published on Sep. 5, 2002 for Mark Mozley et al., describes a system and method for providing a real estate auction system. The Mozley et al. application does not suggest a method and apparatus for real estate agent selection according to the claimed invention.

U.S. Pat. No. 5,664,115, issued on Sep. 2, 1997 to Richard Fraser, describes a method and apparatus of automatically matching sellers or property with potential buyers through a communications network in which a host system communications with the sellers and the potential buyers over telephone or dedicated data transmission lines. The Fraser patent does not suggest a method and apparatus for real estate agent selection according to the claimed invention.

U.S. Pat. No. 5,754,850, issued on May 19, 1998 to Richard R. Janssen, describes a real estate method and apparatus for searching for homes in a search pool for exact and close matches according to primary and non-primary selection criteria. The Janssen patent does not suggest a method and apparatus for real estate agent selection according to the claimed invention.

U.S. Pat. No. 5,794,212, issued on Aug. 11, 1998 to Alfred F. Mistr, Jr., describes a method for providing more efficient communication between energy suppliers, energy purchasers, and transportation providers and having an administrator to assist in the transmission of energy as necessary for providing timely movement of energy. The Mistr, Jr. patent does not suggest a method and apparatus for real estate agent selection according to the claimed invention.

U.S. Pat. No. 5,819,285, issued on Oct. 6, 1998 to Thomas Damico et al., describes an apparatus for capturing and storing a co-marketer identification symbol representing an identity of an entity that has referred a user ton a user station to a computer service, wherein the user station is coupled to the computer service by a communication path. The Damico et al. patent does not suggest a method and apparatus for real estate agent selection according to the claimed invention.

U.S. Pat. No. 5,832,497, issued on Nov. 3, 1998 to Jeffrey C. Taylor, describes a computer implemented system to manage the exchange of information through two databases. The Taylor patent does not suggest a method and apparatus for real estate agent selection according to the claimed invention.

U.S. Pat. No. 5,950,173, issued on Sep. 7, 1999 to Thomas J. Perkowski, describes a system and method for finding and serving consumer product-related information over the Internet to consumers in retail shopping environments, as well as at home and work, and on the road. The Perkowski patent does not suggest a method and apparatus for real estate agent selection according to the claimed invention.

U.S. Pat. No. 6,029,141, issued on Feb. 22, 2000 to Jeffrey P. Bezos et al., describes an Internet-based referral system that enables individuals and other business entities to market products, in return for a commission, that are sold from a merchant's Web site. The Bezos et al. patent does not suggest a method and apparatus for real estate agent selection according to the claimed invention.

U.S. Pat. No. 6,055,513, issued on Apr. 25, 2000 to Ronald A. Katz et al., describes methods and apparatuses for effecting remote commerce, and are adapted for the intelligent selection and proffer of products, services or information to a user or customer. The Katz et al. patent does not suggest a method and apparatus for real estate agent selection according to the claimed invention.

U.S. Pat. No. 6,070,185, issued on May 30, 2000 to Vinod Anupam et al., describes a technique for obtaining information and services over a communications network. The Anupam et al. patent does not suggest a method and apparatus for real estate agent selection according to the claimed invention.

U.S. Pat. No. 6,131,095, issued on Oct. 10, 2000 to Colin Low et al., describes a method of accessing a target entity over a communications network. The Fraser patent does not suggest a method and apparatus for real estate agent selection according to the claimed invention.

U.S. Pat. No. 6,314,404 B1, issued on Nov. 6, 2001 to Robert O. Good et al., describes a method for managing real estate referrals in which the referrals are made by a broker for residential real estate. The Good et al. patent does not suggest a method and apparatus for real estate agent selection according to the claimed invention.

U.S. Pat. No. 6,321,202 B1, issued on Nov. 20, 2001 to William M. Raveis, Jr., describes a system and method for managing real estate transactions. The Raveis, Jr. patent does not suggest a method and apparatus for real estate agent selection according to the claimed invention.

Japan Patent document 7-271854, published on Oct. 20, 1995, describes a data processing system for real estate object intermediary business for recommending real estate objects in accordance with a customer's request and processing a customer's reservation request or the like of the real estate object. The Japan '854 document does not suggest a method and apparatus for real estate agent selection according to the claimed invention.

Japan Patent document 8-315006, published on Nov. 29, 1996, describes a real estate intermediary business supporting system. The Japan '006 document does not suggest a method and apparatus for real estate agent selection according to the claimed invention.

None of the above inventions and patents, taken either singularly or in combination, is seen to describe the instant invention as claimed.

### SUMMARY OF THE INVENTION

The present invention provides a method and apparatus for real estate agent selection based on real estate agent data based on performance. An apparatus for real estate real estate agent selection includes at least one real estate customer, a real estate server, and a real estate agent database.

As used herein, a real estate customer refers to either a non-wireless or wireless computing device configured for use by a user. For example, a real estate customer may be any known personal computer that is communicatively interconnected with the real estate server and the real estate agent database. The real estate customer includes a central processing unit (CPU), memory, and a modem.

The real estate server includes a CPU, memory, and a modem. The CPU includes an arithmetic/logic unit that is interconnected with the memory via a communication bus. The memory includes a read only memory (ROM) and a random access memory (RAM). The ROM stores computer readable program code means that is read and processed by the CPU, and that causes the CPU to perform programmed functions. Movement and process of instructions as well as data is controlled and accomplished by the CPU. The RAM and the ROM may be connected to the microprocessor through several signal paths.

The CPU may execute various programs under the control of the operating system of the real estate customer. For example, any computer readable software code means stored in the ROM of the real estate server may include:

first instruction means for providing a first input window image on a real estate agent customer for obtaining data regarding whether the customer is interested in selling or buying real estate property;

second instruction means for receiving selling or buying input data from the real estate agent customer;

third instruction means for providing a second input window image on the real estate agent customer for obtaining real estate property associated with the received selling or buying input data from the real estate agent customer;

fourth instruction means for receiving real estate property data associated with the received selling or buying input data from the real estate agent customer;

fifth instruction means for providing a fourth input window image on the real estate agent customer for obtaining, data regarding the real estate agent customer;

sixth instruction means for receiving real estate agent customer data from the real estate agent customer;

seventh instruction means for evaluating the received seller or buyer input data, the received real estate property data associated with the received selling or buying input data, and the received real estate agent customer data;

eighth instruction means for accessing a real estate agent database and determining at least one real estate agent based on the received seller or buyer input data, the received real estate property data associated with the,received selling or buying input data, and the received real estate agent customer data, the at least one real estate agent having earned more than a predetermined amount during a designated time period;

ninth instruction means for providing data pertaining to the determined at least one real estate agent to the real estate agent customer;

tenth instruction means for instructing the real estate agent customer to interview the at least one real estate agent and to provide data regarding any selected real estate agent after conducting an interview with the at least one real estate agent;

eleventh instruction means for receiving data regarding any selected real estate agent from the real estate agent customer;

twelfth instruction means for reperforming the eighth, ninth, and tenth instruction means if the real estate agent customer becomes dissatisfied with any selected real estate agent;

thirteenth instruction means for receiving selling or buying closing data from a selected real estate agent; or the like.

Any computer readable software code means stored in the ROM of the real estate server may also include fourteenth instruction means for periodically updating the real estate agent database with real estate data.

A method for real estate agent selection provides at least one real estate customer, a real estate server, and a real estate agent database. The method then provides a first input window image on a real estate agent customer for obtaining data regarding whether the customer is interested in selling or buying real estate property, and receives selling or buying input data from the real estate agent customer. The method then provides a second input window image on the real estate agent customer for obtaining real estate property associated with the received selling or buying input data from the real estate agent customer, and receives real estate property data associated with the received selling or buying input data from the real estate agent customer. The method then provides a third input window image on the real estate agent customer for obtaining data regarding the real estate agent customer, and receives real estate agent customer data from the real estate agent customer.

The method then evaluates the received seller or buyer input data, the received real estate property data associated with the received selling or buying input data, and the received real estate agent customer data, and determines at least one real estate agent based on the received seller or buyer input data, the received real estate property data associated with the received selling or buying input data, and the received real estate agent customer data, the at least one real estate agent having earned more than a predetermined amount during a designated time period.

The method then provides data pertaining to the determined at least one real estate agent to the real estate agent customer, and instructs the real estate agent customer to interview the at least one real estate agent and to provide data regarding any selected real estate agent after conducting an interview with the at least one real estate agent, and receives data regarding any selected real estate agent from the real estate agent customer. The method reperforms the evaluating, providing, and instructing steps regarding the real estate agents if the real estate agent customer becomes dissatisfied with any selected real estate agent. The method receives selling or buying closing data from a selected real estate agent, and the selected real estate agent pays an operator of the real estate server a referral fee closing a real estate transaction for the real estate customer. The method may also periodically update the real estate agent database with current real estate agent data.

Accordingly, it is a principal aspect of the invention to provide an apparatus for real estate agent selection including at least one real estate customer, a real estate server communicatively connected with the at least one real estate customer, and a real estate agent database communicatively connected with the real estate server, wherein the real estate agent database stores data only on real estate agents who having earned more than a predetermined amount during a designated time period.

It is another aspect of the invention to provide an apparatus for real estate agent selection including at least one real estate customer, a real estate server communicatively connected with the at least one real estate customer, and a real estate agent database communicatively connected with the real estate server, wherein the real estate agent database stores data only on real estate agents who having earned more than a predetermined amount during a designated time period, wherein the real estate server includes computer readable software code means, the computer readable software code means including:

first instruction means for providing a first input window image on a real estate agent customer for obtaining data regarding whether the customer is interested in selling or buying real estate property;

second instruction means for receiving selling or buying input data from the real estate agent customer;

third instruction means for providing a second input window image on the real estate agent customer for obtaining real estate property associated with the received selling or buying input data from the real estate agent customer;

fourth instruction means for receiving real estate property data associated with the received selling or buying input data from the real estate agent customer;

fifth instruction means for providing a third input window image on the real estate agent customer for obtaining data regarding the real estate agent customer;

sixth instruction means for receiving real estate agent customer data from the real estate agent customer;

seventh instruction means for evaluating the received seller or buyer input data, the received real estate property data associated with the received selling or buying input data, and the received real estate agent customer data; and

eighth instruction means for accessing a real estate agent database and determining at least one real estate agent based on the received seller or buyer input data, the received real estate property data associated with the received selling or buying input data, and the received real estate agent customer data, the at least one real estate agent having earned more than a predetermined amount during a designated time period.

It is a further aspect of the invention to an apparatus for real estate agent selection including at least one real estate customer, a real estate server communicatively connected with the at least one real estate customer, and a real estate agent database communicatively connected with the real estate server, wherein the real estate agent database stores data only on real estate agents who having earned more than a predetermined amount during a designated time period, wherein the real estate server includes computer readable software code means, the computer readable software code means including:

first instruction means for providing a first input window image on a real estate agent customer for obtaining data regarding whether the customer is interested in selling or buying real estate property;

second instruction means for receiving selling or buying input data from the real estate agent customer;

third instruction means for providing a second input window image on the real estate agent customer for obtaining real estate property associated with the received selling or buying input data from the real estate agent customer;

fourth instruction means for receiving real estate property data associated with the received selling or buying input data from the real estate agent customer;

fifth instruction means for providing a third input window image on the real estate agent customer for obtaining data regarding the real estate agent customer;

sixth instruction means for receiving real estate agent customer data from the real estate agent customer;

seventh instruction means for evaluating the received seller or buyer input data, the received real estate property data associated with the received selling or buying input data, and the received real estate agent customer data;

eight instruction means for accessing a real estate agent database and determining at least one real estate agent based on the received seller or buyer input data, the received real estate property data associated with the received selling or buying input data, and the received real estate agent customer data, the at least one real estate agent having earned more than a predetermined amount during a designated time period;

ninth instruction means for providing data pertaining to the determined at least one real estate agent to the real estate agent customer;

tenth instruction means for instructing the real estate agent customer to interview the at least one real estate agent and to provide data regarding any selected real estate agent after conducting an interview with the at least one real estate agent;

eleventh instruction means for receiving data regarding any selected real estate agent from the real estate agent customer;

twelfth instruction means for reperforming the eighth, ninth, and tenth instruction means if the real estate agent customer becomes dissatisfied with any selected real estate agent;

thirteenth instruction means for receiving selling or buying closing data from a selected real estate agent; and

fourteenth instruction means for periodically updating the real estate agent database with real estate data.

Still another aspect of the invention is to provide a method for real estate agent selection, the method including providing at least one real estate customer;

providing a real estate server communicatively connected to the at least one real estate customer;

providing a real estate agent database communicatively connected to the real estate server;

providing a first input window image on a real estate agent customer for obtaining data regarding whether the real estate customer is interested in selling or buying real estate property;

receiving selling or buying input data from the real estate agent customer;

providing a second input window image on the real estate agent customer for obtaining real estate property associated with the received selling or buying input data from the real estate agent customer;

receiving real estate property data associated with the received selling or buying input data from the real estate agent customer;

providing a third input window image on the real estate agent customer for obtaining data regarding the real estate agent customer;

receiving real estate agent customer data from the real estate agent customer; evaluating the received seller or buyer input data, the received real estate property data associated with the received selling or buying input data, and the received real estate agent customer data; and

accessing a real estate agent database and determining at least one real estate agent based on the received seller or buyer input data, the received real estate property data associated with the received selling or buying input data, and the received real estate agent customer data, the at least one real estate agent having earned more than a predetermined amount during a designated time period.

Yet another aspect of the invention is to provide a method for real estate agent selection, the method including providing at least one real estate customer;

providing a real estate server communicatively connected to the at least one real estate customer;

providing a real estate agent database communicatively connected to the real estate server;

providing a first input window image on a real estate agent customer for obtaining data regarding whether the real estate customer is interested in selling or buying real estate property; receiving selling or buying input data from the real estate agent customer;

providing a second input window image on the real estate agent customer for obtaining real estate property associated with the received selling or buying input data from the real estate agent customer;

receiving real estate property data associated with the received selling or buying input data from the real estate agent customer;

providing a third input window image on the real estate agent customer for obtaining data regarding the real estate agent customer;

receiving real estate agent customer data from the real estate agent customer;

evaluating the received seller or buyer input data, the received real estate property data associated with the received selling or buying input data, and the received real estate agent customer data;

accessing a real estate agent database and determining at least one real estate agent based on the received seller or buyer input data, the received real estate property data associated with the received selling or buying input data, and the received real estate agent customer data, the at least one real estate agent having earned more than a predetermined amount during a designated time period;

providing data pertaining to the determined at least one real estate agent to the real estate agent customer;

instructing the real estate agent customer to interview the at least one real estate agent and to provide data regarding any selected real estate agent after conducting an interview with the at least one real estate agent;

receiving data regarding any selected real estate agent from the real estate agent customer;

reperforming the evaluating, providing, and instructing steps regarding the real estate agents if the real estate agent customer becomes dissatisfied with any selected real estate agent; receiving selling or buying closing data from a selected real estate agent;

receiving a referral fee from the selected real estate agent for closing a real estate transaction for the real estate customer; and

periodically updating the real estate agent database with real estate data.

It is an aspect of the invention to provide improved elements and arrangements thereof for the purposes in a method and apparatus for real estate agent selection described which is inexpensive, dependable and fully effective in accomplishing its intended purposes.

These and other aspects of the present invention will become readily apparent upon further review of the following specification and drawings.

### BRIEF DESCRIPTION OF THE DRAWINGS

FIG. 1 is a block diagram of an apparatus for real estate agent selection according to the present invention.

FIGS. 2A and 2B are a flow chart of a for real estate agent selection according to the present invention.

Similar reference characters denote corresponding features consistently throughout the attached drawings.

### DETAILED DESCRIPTION OF THE PREFERRED EMBODIMENTS

The present invention is a method and apparatus for real estate agent selection. The invention disclosed herein is, of course, susceptible of embodiment in many different forms. Shown in the drawings and described hereinbelow in detail are preferred embodiments of the invention. It is to be understood, however, that the present disclosure is an exemplification of the principles of the invention and does not limit the invention to the illustrated embodiments.

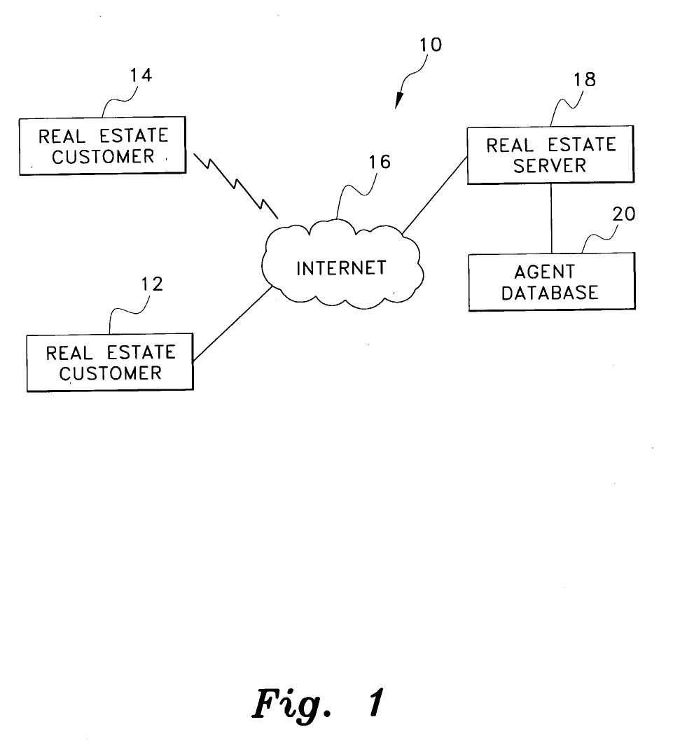

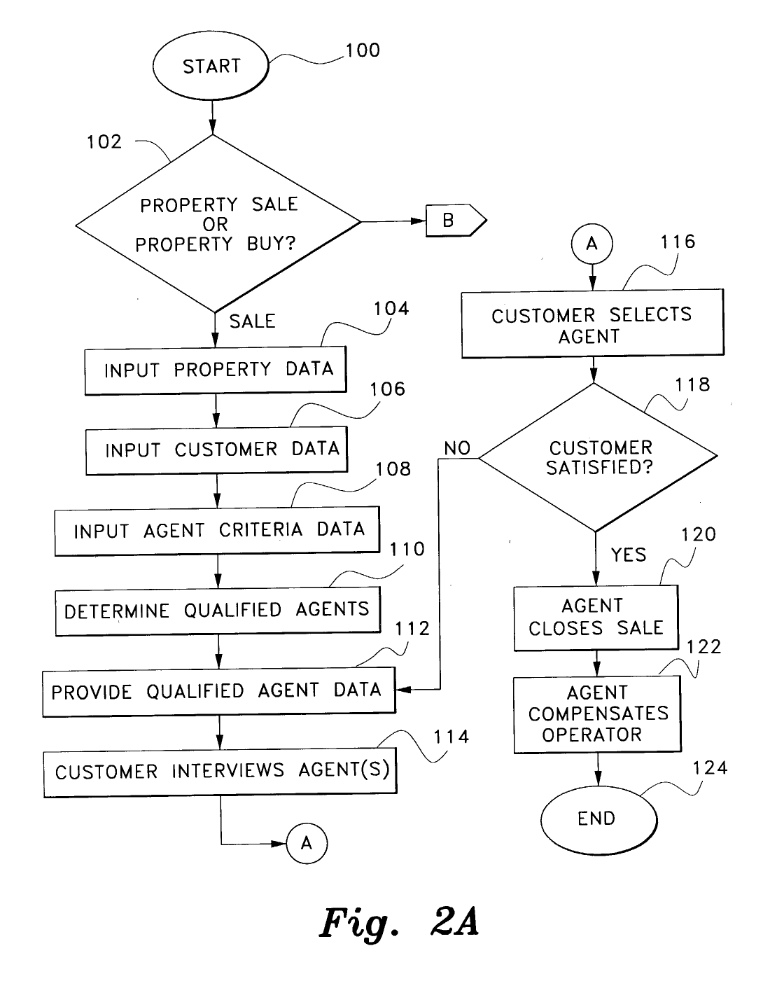

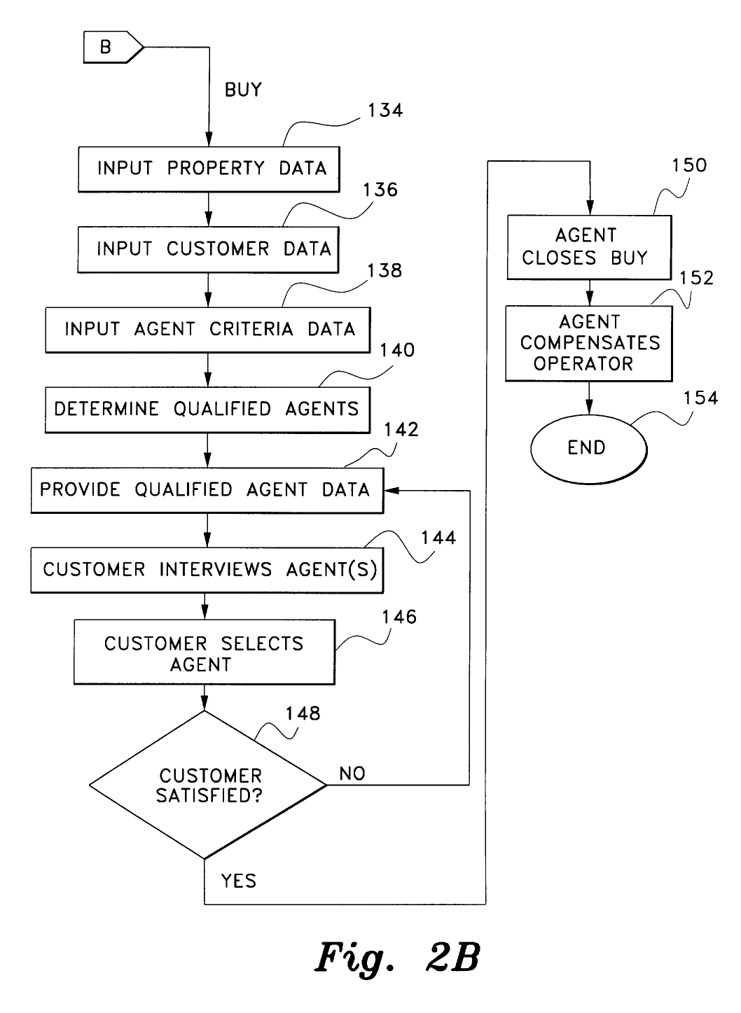

Referring to FIG. 1, an apparatus 10 for real estate real estate agent selection includes at least one real estate customer 12, 14, a real estate server 18, and a real estate agent database 20. As used herein, a real estate customer refers to either a non-wireless or wireless computing device configured for use by a user. For example, a real estate customer may be any known personal computer that is communicatively interconnected with the real estate server and the real estate agent database. The real estate customer includes a central processing unit (CPU) memory, and a modem.

The real estate server 18 includes a CPU, memory, and a modem. The CPU includes an arithmetic/logic unit that is interconnected with the memory via a communication bus. The memory includes a read only memory (ROM) and a random access memory (RAM). The ROM stores computer readable program code means that is read and processed by the CPU, and that causes the CPU to perform programmed functions. Movement and process of instructions as well as data is controlled and accomplished by the CPU. The RAM and the ROM may be connected to the microprocessor through several signal paths.

The CPU may execute various programs under the control of the operating system of the real estate customer. For example, any computer readable software code means stored in the ROM of the real estate server may include:

first instruction means for providing a first input window image on a real estate agent customer for obtaining data regarding whether the customer is interested in selling or buying real estate property;

second instruction means for receiving selling or buying input data from the real estate agent customer;

third instruction means for providing a second input window image on the real estate agent customer for obtaining real estate property associated with the received selling or buying input data from the real estate agent customer;

fourth instruction means for receiving real estate property data associated with the received selling or buying input data from the real estate agent customer;

fifth instruction means for providing a third input window image on the real estate agent customer for obtaining data regarding the real estate agent customer;

sixth instruction means for receiving real estate agent customer data from the real estate agent customer;

seventh instruction means for evaluating the received seller or buyer input data, the received real estate property data associated with the received selling or buying input data, and the received real estate agent customer data;

eighth instruction means for accessing a real estate agent database and determining at least one real estate agent based on the received seller or buyer input data, the received real estate property data associated with the received selling or buying input data, and the received real estate agent customer data, the at least one real estate agent having earned more than a predetermined amount during a designated time period;

ninth instruction means for providing data pertaining to the determined at least one real estate agent to the real estate agent customer;

tenth instruction means for instructing the real estate agent customer to interview the at least one real estate agent and to provide data regarding any selected real estate agent after conducting an interview with the at least one real estate agent;

eleventh instruction means for receiving data regarding any selected real estate agent from the real estate agent customer;

twelfth instruction means for reperforming the eighth, ninth, and tenth instruction means if the real estate agent customer becomes dissatisfied with any selected real estate agent;

thirteenth instruction means for receiving selling or buying closing data from a selected real estate agent; or the like.

Any computer readable software code means stored in the ROM of the real estate server may also include fourteenth instruction means for periodically updating the real estate agent database with real estate data.

A method for real estate agent selection provides at least one real estate customer, a real estate server, and a real estate agent database. The method then provides a first input window image on a real estate agent customer for obtaining data regarding whether the customer is interested in selling or buying real estate property, and receives selling or buying input data from the real estate agent customer. The method then provides a second input window image on the real estate agent customer for obtaining real estate property associated with the received selling or buying input data from the real estate agent customer, and receives real estate property data associated with the received selling or buying input data from the real estate agent customer. For example, the second input window image may include address data input, number of bedroom data input, property type data, square footage data, or the like.

The method then provides a third input window image on the real estate agent customer for obtaining data regarding the real estate agent customer, and receives real estate agent customer data from the real estate agent customer. For example, customer data may include name data, email data, telephone number data, transaction treasons, transaction prices, or the like.

The method then evaluates the received seller or buyer input data, the received real estate property data associated with the received selling or buying input data, and the received real estate agent customer data, and determines at least one real estate agent based on the received seller or buyer input data, the received real estate property data associated with the received selling or buying input data, and the received real estate agent customer data, the at least one real estate agent having earned more than a predetermined amount during a designated time period.

The method then provides data pertaining to the determined at least one real estate agent to the real estate agent customer, and instructs the real estate agent customer to interview the at least one real estate agent and to provide data regarding any selected real estate agent after conducting an interview with the at least one real estate agent, and receives data regarding any selected real estate agent from the real estate agent customer. The method reperforms the evaluating, providing, and instructing steps regarding the real estate agents if the real estate agent customer becomes dissatisfied with any selected real estate agent. The method receives selling or buying closing data from a selected real estate agent, and the selected real estate agent pays an operator of the real estate server a referral fee closing a real estate transaction for the real estate customer. The method may also periodically update the real estate agent database with current real estate agent data.

While the invention has been described with references to its preferred embodiment, it will be understood by those skilled in the art that various changes may be made and equivalents may be substituted for elements thereof without departing from the true spirit and scope of the invention. In addition, many modifications may be made to adapt a particular situation or material to the teaching of the invention without departing from its essential teachings.

I claim:

1. An apparatus for real estate agent selection comprising:
at least one real estate customer;
a real estate server communicatively connected with said at least one real estate customer; and
a real estate agent database communicatively connected with said real estate server,
wherein the real estate agent database stores data only on real estate agents who having earned more than a predetermined amount during a designated time period.

2. The apparatus according to claim 1, wherein the real estate server includes computer readable software code means, said computer readable software code means comprising:
first instruction means for providing a first input window image on a real estate agent customer for obtaining data regarding whether the customer is interested in selling or buying real estate property;
second instruction means for receiving selling or buying input data from the real estate agent customer;
third instruction means for providing a second input window image on the real estate agent customer for obtaining real estate property associated with the received selling or buying input data from the real estate agent customer;
fourth instruction means for receiving real estate property data associated with the received selling or buying input data from the real estate agent customer;
fifth instruction means for providing a third input window image on the real estate agent customer for obtaining data regarding the real estate agent customer;
sixth instruction means for receiving real estate agent customer data from the real estate agent customer;
seventh instruction means for evaluating the received seller or buyer input data, the received real estate property data associated with the received selling or buying input data, and the received real estate agent customer data; and
eighth instruction means for accessing a real estate agent database and determining at least one real estate agent based on the received seller or buyer input data, the received real estate property data associated with the received selling or buying input data, and the received real estate agent customer data, the at least one real estate agent having earned more than a predetermined amount during a designated time period;

3. The apparatus according to claim 2, wherein said computer readable software code means further comprises:
ninth instruction means for providing data pertaining to the determined at least one real estate agent to the real estate agent customer;
tenth instruction means for instructing the real estate agent customer to interview the at least one real estate agent and to provide data regarding any selected real estate agent after conducting an interview with the at least one real estate agent;
eleventh instruction means for receiving data regarding any selected real estate agent from the real estate agent customer;
twelfth instruction means for reperforming the eighth, ninth, and tenth instruction means if the real estate agent customer becomes dissatisfied with any selected real estate agent; and
thirteenth instruction means for receiving selling or buying closing data from a selected real estate agent.

4. The apparatus according to claim 3, wherein said computer readable software code means further comprises:
fourteenth instruction means for periodically updating the real estate agent database with real estate data.

5. A method for real estate agent selection, said method comprising:
providing at least one real estate customer
providing a real estate server communicatively connected to the at least one real estate customer;
providing a real estate agent database communicatively connected to the real estate server;
providing a first input window image on a real estate agent customer for obtaining data regarding whether the real estate customer is interested in selling or buying real estate property;
receiving selling or buying input data from the real estate agent customer;
providing a second input window image on the real estate agent customer for obtaining real estate property associated with the received selling or buying input data from the real estate agent customer;
receiving real estate property data associated with the received selling or buying input data from the real estate agent customer;
providing a third input window image on the real estate agent customer for obtaining data regarding the real estate agent customer;
receiving real estate agent customer data from the real estate agent customer;
evaluating the received seller or buyer input data, the received real estate property data associated with the received selling or buying input data, and the received real estate agent customer data; and
accessing a real estate agent database and determining at least one real estate agent based on the received seller or buyer input data, the received real estate property data associated with the received selling or buying input data, and the received real estate agent customer data, the at least one real estate agent having earned more than a predetermined amount during a designated time period.

6. The method according to claim 3, further comprising:
providing data pertaining to the determined at least one real estate agent to the real estate agent customer;
instructing the real estate agent customer to interview the at least one real estate agent and to provide data regarding any selected real estate agent after conducting an interview with the at least one real estate agent;
receiving data regarding any selected real estate agent from the real estate agent customer;
reperforming the evaluating, providing, and instructing steps regarding the real estate agents if the real estate agent customer becomes dissatisfied with any selected real estate agent; and
receiving selling or buying closing data from a selected real estate agent; and
receiving a referral fee from the selected real estate agent for closing a real estate transaction for the real estate customer.

7. The method according to claim 6, further comprising periodically updating the real estate agent database with real estate data.
